(19) United States
(12) Patent Application Publication
(10) Pub. No.: US 2015/0114755 A1
(43) Pub. Date: Apr. 30, 2015

(54) MARINE LADDER

(71) Applicant: Rosalie Helen EAMES, Frankford (CA)

(72) Inventor: Rosalie Helen EAMES, Frankford (CA)

(21) Appl. No.: 14/530,401

(22) Filed: Oct. 31, 2014

Related U.S. Application Data
(60) Provisional application No. 61/897,934, filed on Oct. 31, 2013.

(51) Int. Cl. E06C 1/38; B63B 27/14; E06C 7/08

(52) U.S. Cl. CPC E06C 1/38; E06C 7/08; B63B 27/146
USPC 182/207; 182/194

(57) ABSTRACT

A marine ladder comprising a pair of laterally spaced step support members having a plurality of steps secured therebetween; said steps positioned between a lower portion and an upper portion of said step support members; an attachment member to secure said ladder to a platform; an adjustable support leg extending outwardly to abut a portion of said platform thereby positioning said steps in a generally horizontal plane; and wherein each successive step from said upper portion to said lower portion has a larger step tread than a preceding step.

### CROSS-REFERENCE TO RELATED APPLICATIONS

This application claims the benefit of priority to U.S. Provisional Application Ser. No. 61/897,934 filed on Oct. 31, 2013.

### FIELD OF THE INVENTION

The present invention relates to ladders, and more particularly it relates to a ladder for use with an aquatic platform, such as a boat, a dock or a raft.

### DESCRIPTION OF THE RELATED ART

Existing marine ladders can be difficult to use for persons who are elderly, have decreased mobility or are encumbered by swim gear (i.e. SCUBA gear, swim fins), water toys (noodles, skies or inner tubes) or other equipment.

Current marine boarding devices generally comprise of either ladders with vertically oriented spaced rungs or sloped stair-like ladders. The former ladders are generally designed as a substantially vertically descending ladder with small steps or rungs. In some cases the boat ladder consists of a single rung that pivots into the water. Many ladder designs are focused on size and compact nature for ease of storage within the limited space of a boat rather than ease of use. Other types of this ladder are rope ladders, which are flexible, collapsible and lightweight; however, their flexibility also makes them difficult to climb. Due to the flexible nature of these designs the ladder may take on a reverse or past vertical slope during use, making it even more difficult to climb.

Another type is a removable ladder which may be adapted to fit in a bracket bolted to the hull or deck. The bracket may include have keyhole slots, or other such release fasteners that hold the ladder securely, yet allow it to be removed for storage. Some ladders fold in half so they can be left in place without dragging in the water and extended when in use. Some ladders have an inverted “U” shaped hand rail at an upper end that is attachable to the boat, the hand rails extending down into the water and have rungs or short steps attached between. Other ladders have a hinge system to allow rotation of, or folding of, the ladder, or a portion thereof, or a slidable mechanism to shorten the ladder, in order to raise the ladder out of the water.

Ladders having a sloped stair-like design include U.S. Pat. No. 5,887,540 that discloses a hinged stairway system that has one or more steps of consistent tread depth and a larger bottom step or a platform. A preferred embodiment includes a swivel ladder attached to the bottom platform step to permit easier access to the stairway.

U.S. Pat. Nos. 7,090,049; 7,464,792; and 8,157,054 disclose aquatic ladders for marine applications, having a pair of sloped step support members between which are mounted a plurality of horizontal steps, each step being the same size, a pair of inverted “U” shaped handrails attachable to a floating platform at a distal end while a proximal end extends downwards to contact the floating platform. The step support members being secured to the hand rail members. A variant is disclosed that uses a pair of standoffs to support the ladder from a pontoon boat.

U.S. Patent Publication No. 2012/0273303 discloses a set of boarding steps configured as a staircase that has a mounting system to connect the boarding steps to a boat ladder. The stair case has side runners between which a plurality of steps are positioned. Each step being the same size as the others.

U.S. Patent Publication No. 2013/0247812 discloses a boarding ladder for animals such as dogs. The stair case has side runners between which a plurality of steps are positioned and is mountable to a boat hull gunwale or transom lip. The mounting mechanism includes a hinge to pivot the boarding ladder out of the water.

It is an object of the present invention to mitigate or obviate at least one of the above-mentioned disadvantages.

### SUMMARY OF THE INVENTION

In one of its aspects, there is provided a ladder for use in an aquatic environment comprising: a pair of laterally spaced step support members; a plurality of steps secured between said step support members; a connector configured to attach the ladder to a platform; a support leg positioned to extend rearward from said ladder and abut a portion of said platform thereby positioning said steps in a generally horizontal plane; and wherein said plurality of steps each have an increasingly larger step tread than a step above it.

In another of its aspects, there is provided a marine ladder comprising a pair of laterally spaced step support members having a plurality of steps secured therebetween; said steps positioned between a lower portion and an upper portion of said step support members; an attachment member to secure said ladder to a platform; an adjustable support leg extending outwardly to abut a portion of said platform thereby positioning said steps in a generally horizontal plane; and wherein each successive step from said upper portion to said lower portion has a larger step tread than a preceding step.

In another of its aspects, there is provided a ladder comprising a pair of laterally spaced step support members having a plurality of steps secured therebetween; said steps positioned between a lower portion and an upper portion of said step support members; an attachment member to secure said ladder to a platform; an adjustable support leg extending outwardly to abut a portion of said platform thereby positioning said steps in a generally horizontal plane; wherein each successive step from said upper portion to said lower portion has a larger step tread than a preceding step; and wherein each of said step support members comprises a front support member and a rear support member and the step support member is configured in a generally obtuse trapezoid shape such that said front support member and said rear support member diverge from each other.

Advantageously, the support leg positions the ladder such that the steps are in a generally horizontal plane, and provides added stability to the ladder.

### BRIEF DESCRIPTION OF THE DRAWINGS

Several exemplary embodiments of the present invention will now be described, by way of example only, with reference to the appended drawings in which:

FIG. 1 is a front perspective view of a stairway ladder, in an exemplary embodiment;

FIG. 2 is a rear perspective view of a stairway ladder;

FIG. 3 is a side view of a stairway ladder; and

FIG. 4 is a front view of a stairway ladder.

### DETAILED DESCRIPTION OF EXEMPLARY EMBODIMENTS

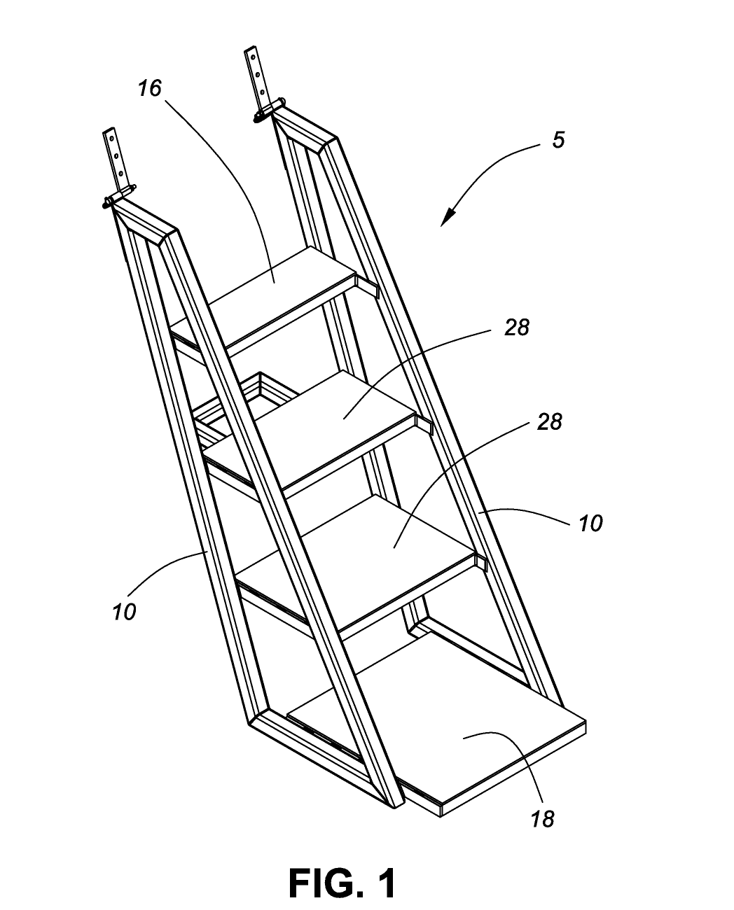

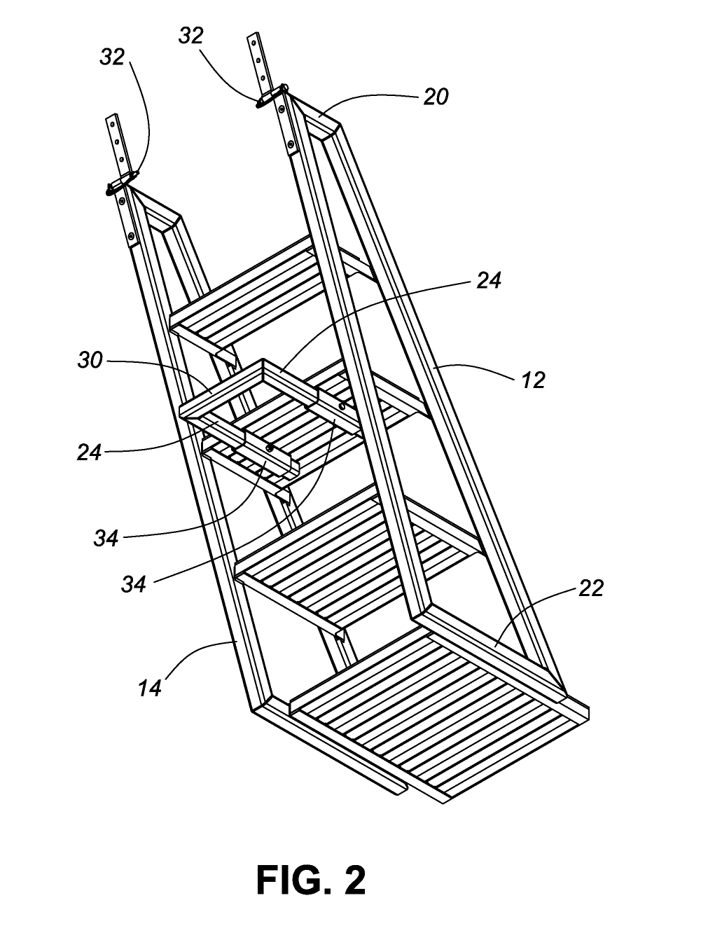

Looking at FIGS. 1 and 2, there is shown a stairway-like ladder generally designated by the numeral 5, in an exemplary embodiment, for use with an aquatic platform. Ladder 5 comprises a pair of laterally spaced, step support members 10, each having a forward support member 12 and a rearward support member 14 with a plurality of steps 16, 18 and 28 secured therebetween. The support members 12, 14 are spaced apart to provide easy climbing access, for example, the distance between support members 12, 14 ranges from 12 to 24 inches, and in one exemplary embodiment the support members 12, 14 are about 16 inches apart. The step support members 10 form a frame for the steps 16, 18 and 28. The front support member 12 and rear support member 14 are joined preferably by an upper support member 20 adjacent to an upper most step 16 and a lower support member 22 adjacent to a lower-most step 18.

The frame has a generally obtuse trapezoid shape where the upper support member 20 and lower support member 22 form the parallel bases of the trapezoid. The generally obtuse trapezoid shape roughly coincides with the increasingly larger steps disposed therebetween, thereby providing support for a step from the front to rear of the step tread. The front support member 12 and rear support member 14 diverge from each other as they extend downward toward the lower-most step 18. The upper most step 16 and the lower most step 18, and a plurality of intermediate steps 28 are secured between the step support members 12, 1. A rear portion of each of steps 16, 18 and 28 is attached to rear support member 14, and a front portion of each of steps 16, 18 and 28 is attached to the forward support member 12. When the lower-most step is a platform step 18, the forward support member 12 is attached at the point the platform step 18 meets the forward support member 12, and a portion of the platform step 18 extends outwardly and beyond the front support member 12. Support members 10 can be formed from a variety of sturdy material that can withstand a marine environment, including a salt-water marine environment. Such materials include, but are not limited to aluminum, aluminum channel, galvanized steel, stainless steel, tubular steel, composite materials such as fiberglass or carbon fiber, and high density plastic. Preferably the support members 10 are aluminum metal and be joined by welds or bolts or be so formed as to be constructed of one or more pieces. The aluminum support members 10 are of suitable gauge and strength as known in the art. In a one embodiment, a ⅛^{th} inch (0.125″) channel tube aluminum, 100 wall gauge (0.100″ thickness) is used.

The steps 16, 18 and 28 may be secured to the frame by welding, fasteners, such as bolts or clip type fastening hardware, or other joining mechanisms. Steps 16, 18 and 28 have sufficient tread depth (i.e. front to rear distance) for easy climbing and are at least 4 inches and preferably at least 5 inches. The step tread increases in step depth at each successive lower step. For example, an upper-most step 16 may have a 6 inch step depth and each successive step increases in step depth by a desired amount, for example 3 inches or between 2 to 4 inches per step. The lower-most step 18 may be extended an additional amount to provide a platform step 18. Preferably the platform step is about 50% larger than the one above it. The platform step 18 is useful to provide easy access to the ladder 5, particularly if swim gear or equipment is being used. The steps 28 have a vertical distance of about 10 inches but may be between 8 to 12 inches as desired. The number of steps 28 may vary depending on the vertical rise between each step and the height of the floating platform above the water. Preferably at least one step is below water and more preferably at least two steps 28 are below the water level. Steps 16, 18 and 28 are preferably made of aluminum and can be comprised of a plurality of C-channel metal bar secured to the step support members 10 via an L-bracket and secured via welding, bolts or other such fastening means. Steps 16, 18 and 28 may be made of other metals or suitably sturdy materials such as hard plastic or composite materials. The steps 16, 18 and 28 may be coated with a non-slip material such as a grip tape or a coating material and may have a patterned surface to provide additional traction to the user.

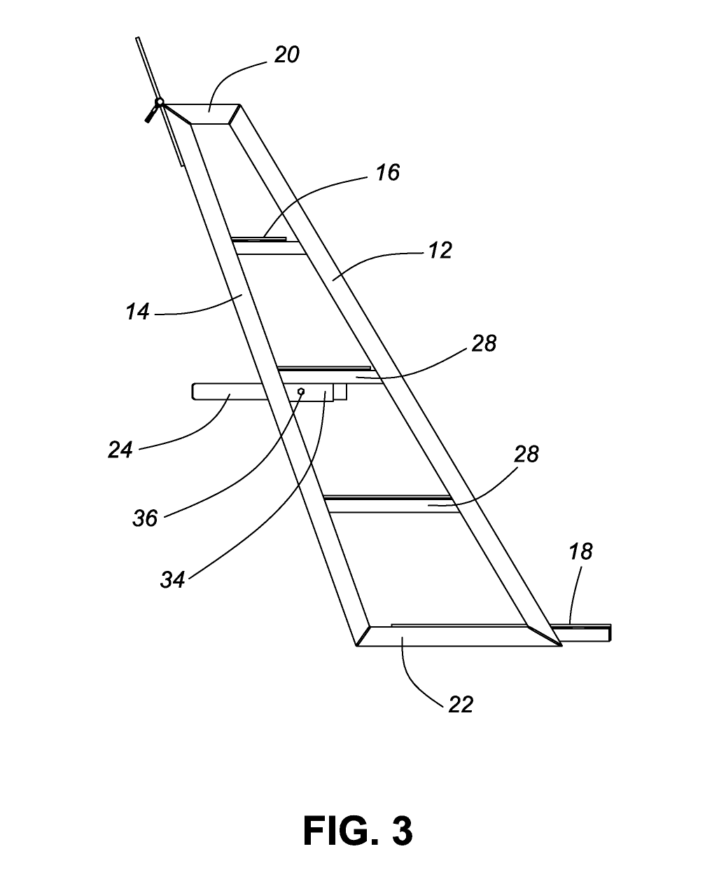

As can be seen in FIGS. 2, 3 and 4, ladder 5 also comprises at least one support leg 24 that extends rearwardly from the ladder 5 and abuts a portion of the floating platform, such as the pontoon. The length of the support leg 24 maintains a proper distance between the floating platform and the ladder 5, and thereby provides the desired ladder slope, including increased positional stability to the stairway ladder 5. The desired ladder slope is one that positions the steps 16, 18 and 28 in a generally horizontal plane. Preferably, the support leg 24 is adjustable such that the ladder 5 is held away from the platform and the steps 16, 18 and 28 are in a generally horizontal plane. The support leg 24 may be attached to a step support member 12, or 14, or to a step 28. Preferably, two support legs 24 are used to provide suitable stability. Looking at FIG. 2, two support legs 24 are joined by a support bar 30 which contacts the floating platform. The support leg 24 may further comprises a length adjustment means to alter the distance between the ladder 5 and the floating platform. Adjustment means may be provided by having the support legs 24 comprising a telescoping portion, for example, leg portions that are slideably adjustable and provide a telescoping type adjustment held in the desired position by a pin or bolt. Alternatively, the leg 24 may pass through a collar 34 secured to the ladder frame or step 28 wherein holes in the collar 34 and complementary holes in support leg 24 align to allow a pin or bolt 36 to pass therethrough, and set a desired leg length. Other length adjustment means are contemplated and adaptable, such as a threaded screw portion or a friction lock.

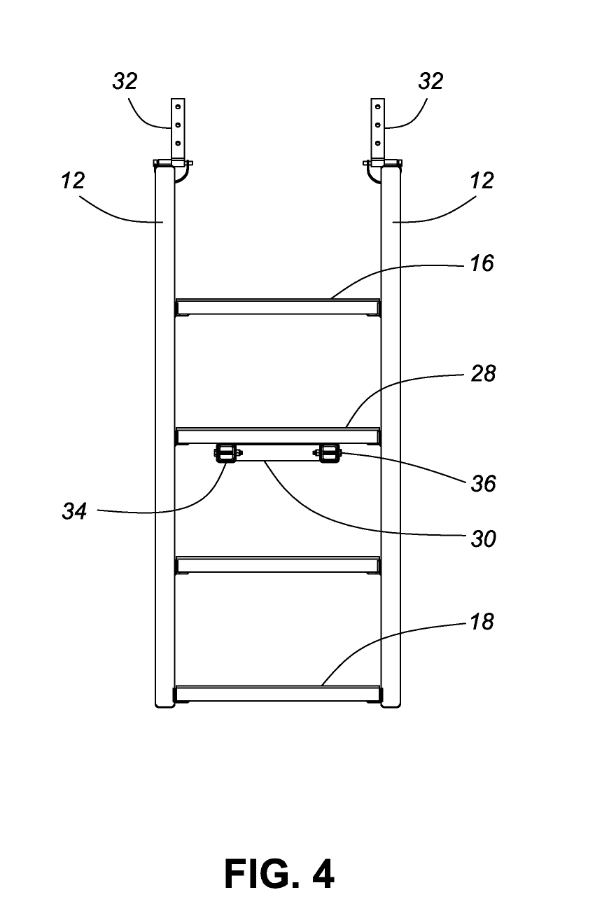

Ladder 5 further comprises a connector for securement to the platform, such as hinged attachment means 32. As can be best seen in FIGS. 2 and 4, a pair of hinges 32 may be affixed to the upper portion 26 of the ladder frame and are secured to the floating platform deck to allow the ladder 5 to be rotated into a raised position. In a raised position the ladder 5 is held out of the water. Alternatively, a single elongated hinge may be used, as may other configurations and types of hinges. In an alternative embodiment, the stairway ladder 5 may be attached to the platform by bolts or quick release fastening hardware that permits the ladder 5 to be removed from the floating platform and stored.

In another embodiment, forward support member 12, rearward support member 14, upper support member 20 and lower support member 22 are manufactured as a unitary piece, or as two or more pieces joined together.

In another embodiment, steps 16, 18 and 28 comprise apertures to permit flow of water therethrough to facilitate deployment in water or removal therefrom.

Ladder 5 may be used with a floating platform such as a dock, a raft, and a boat. In one embodiment the ladder 5 is used with a boat, in particular a pontoon boat. Common pontoon boat designs include a catamaran with two pontoons, or a trimaran with three pontoons. A pontoon typically has a generally circular or elongated-circular cross-section and at a rearward end, a generally flattened surface. A pontoon boat typically has a deck with a railing around the deck perimeter. Typically gates provide passage through the railing, a stern gate generally located over the rearward end of the pontoon and a midsection gate along a side of the boat to allow access to and from the boat.

Further use is contemplated as a pool ladder.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1. A ladder for use in an aquatic environment comprising:
a pair of laterally spaced step support members;
a plurality of steps secured between said step support members;
a connector configured to attach the ladder to a platform;
a support leg positioned to extend rearward from said ladder and abut a portion of said platform thereby positioning said steps in a generally horizontal plane; and
wherein said plurality of steps each have an increasingly larger step tread than a step above it.

2. The ladder of claim 1, further comprising a lower-most step that is a platform step.

3. The ladder of claim 1, wherein each successive step is 3 inches larger than the one above it.

4. The ladder of claim 1, wherein each of said step support members comprises a front support member and a rear support member and the step support member is configured in a generally obtuse trapezoid shape such that said front support member and said rear support member diverge from each other as they extend downward toward the lower-most step.

5. The ladder of claim 4, wherein said plurality of steps comprise a non-slip mechanism to provide traction.

6. The ladder of claim 4, wherein said plurality of steps comprise apertures to permit flow of water therethrough to facilitate deployment in water or removal therefrom.

7. The ladder of claim 4, wherein said support leg has an adjustable length.

8. The ladder of claim 7, wherein said support leg comprises a telescoping portion slidably received by a collar securedly attached to at least one of said step support members and one of said plurality of steps.

9. The ladder of claim 8, wherein said telescoping portion is fixedly maintained at a desired length by a fastener.

10. The ladder of claim 9, wherein said desired length is chosen to provide a desired ladder slope, such that said plurality of steps are in a substantially horizontal plane.

11. The ladder of claim 10, wherein said telescoping portion comprises a series of apertures along its length, and said collar comprises a series of complementary apertures, such that two apertures are aligned and a pin or bolt is introduced therethrough to fixedly maintain said support leg at said desired length.

12. The ladder of claim 10, wherein fastener comprises at least one of a bolt, quick release fastening mechanism, and threaded member.

13. A marine ladder comprising:
a pair of laterally spaced step support members having a plurality of steps secured therebetween; said steps positioned between a lower portion and an upper portion of said step support members;
an attachment member to secure said ladder to a platform;
an adjustable support leg extending outwardly to abut a portion of said platform thereby positioning said steps in a generally horizontal plane; and
wherein each successive step from said upper portion to said lower portion has a larger step tread than a preceding step.

14. The marine ladder of claim 13, wherein said step support members comprise an obtuse trapezoidal shape.

15. The marine ladder of claim 14, wherein each of said step support members comprises a forward support member, a rearward support member, an upper support member and a lower support member.

16. The marine ladder of claim 15, wherein one of said plurality of steps closest to said lower portion forms a platform step, and extends outwardly beyond said forward support member.

17. The marine ladder of claim 15, wherein said attachment member is hingedly connected to said rearward support member.

18. The marine ladder of claim 17, wherein said platform is floating.

19. A ladder comprising:
a pair of laterally spaced step support members having a plurality of steps secured therebetween; said steps positioned between a lower portion and an upper portion of said step support members;
an attachment member to secure said ladder to a platform;
an adjustable support leg extending outwardly to abut a portion of said platform thereby positioning said steps in a generally horizontal plane;
wherein each successive step from said upper portion to said lower portion has a larger step tread than a preceding step; and
wherein each of said step support members comprises a front support member and a rear support member and the step support member is configured in a generally obtuse trapezoid shape such that said front support member and said rear support member diverge from each other.

20. The ladder of claim 19, wherein said adjustable support leg comprises a telescoping portion having a series of apertures along its length, said telescoping portion being received by a collar secured to one of said plurality of steps, and maintained at a desired length.
